(19) United States
(12) Patent Application Publication
(10) Pub. No.: US 2014/0342265 A1
(43) Pub. Date: Nov. 20, 2014

(54) FUEL CELL SYSTEMS

(71) Applicant: Société BIC, Clichy (FR)

(72) Inventors: Anna Stukas, Vancouver (CA); Gerard F. McLean, West Vancouver (CA); Jeremy Schrooten, Mission (CA); Paul Sobejko, Monroe, CT (US)

(73) Assignee: Société BIC, Clichy (FR)

(21) Appl. No.: 14/294,890

(22) Filed: Jun. 3, 2014

Related U.S. Application Data
(63) Continuation of application No. 12/238,040, filed on Sep. 25, 2008.
(60) Provisional application No. 60/975,130, filed on Sep. 25, 2007.

(51) Int. Cl. H01M 8/24; H01M 8/02

(52) U.S. Cl. CPC H01M 8/2485; H01M 8/0258; H01M 8/0271
USPC 429/460; 429/514

(57) ABSTRACT

Described herein are fuel cell systems that include fuel cell covers, as well as electronic systems and methods for optimizing the performance of a fuel cell system. In the various embodiments, a fuel cell cover includes an interface structure proximate to one or more fuel cells. The interface structure is configured to affect one or more environmental conditions proximate to the one or more fuel cells. An electronic system includes an electronic device, one or more fuel cells operably coupled to the electronic device, and an interface structure proximate to the one or more fuel cells. The interface structure affects one or more environmental conditions near or in contact with the one or more fuel cells. A method includes providing a fuel cell layer, and positioning an interface layer proximate to the fuel cell layer.

### PRIORITY OF INVENTION

This non-provisional application claims the benefit of priority under 35 U.S.C. §119(e) to U.S. Provisional Patent Application Ser. No. 60/975,130, filed Sep. 25, 2007, and U.S. Utility patent application Ser. No. 12/238,040 which was filed on Jun. 3, 2014, and published as U.S. Patent Application Publication No. 2009/0081523. The entire teachings of both of these applications are incorporated herein by reference.

### BACKGROUND

Electrochemical cells, such as fuel cells, may utilize oxygen from the environment as a reactant. While generating electricity, the electrochemical reaction that occurs in the cell also produces water that may be directed to other electrochemical cell uses, such as membrane hydration or to the humidification of various parts of the system. The increased functionality of fuel cells for powering electronic devices now introduces the fuel cells to various environmental conditions that may affect gas transport properties of the reactants and the water management system.

Fuel cells may require that the gas diffusion layer or the interface between at least part of the cathode and the environment be electrically conductive for proper cell functionality. Because the interface may be electrically conductive, the suitability of the interface for varying environmental conditions may be limited.

### BRIEF DESCRIPTION OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, various embodiments discussed in the present document.

FIG. 1 illustrates a perspective view of a fuel cell cover with features, according to the various embodiments.

FIG. 2 illustrates a perspective view of a fuel cell cover including a removable access plate, according to the various embodiments.

FIG. 3 illustrates a perspective view of an electronic device including a fuel cell cover, according to the various embodiments.

FIG. 4 illustrates a perspective view of an electronic device including a cover substantially flush with the device, according to the various embodiments.

FIG. 5 illustrates a perspective view of an electronic device with a fuel cell cover including a removable access plate, according to the various embodiments.

FIG. 6 illustrates an exploded view of an electronic device system, according to the various embodiments.

FIG. 7 illustrates an exploded view of a fuel cell system, the fuel cell system including an enclosed region deformable into a fluid plenum when pressurized, according to some embodiments.

FIG. 8 illustrates a cross-sectional view of portions of a fuel cell system, including a fluid manifold, a bond member, and at least one fuel cell, according to some embodiments.

FIGS. 9A-9E illustrate simplified cross-sectional various views in which either the fuel cell layer or the fluid manifold or both deform to create a fluid plenum when the enclosed region is pressurized, according to some embodiments.

FIG. 10A illustrates an isometric view of a portable electronic device powered by a fuel cell system, according to some embodiments.

FIG. 10B illustrates a cross-sectional view of a portable electronic device powered by a fuel cell system, such as along line 1003B-1003B of FIG. 10A, according to some embodiments.

FIG. 11 illustrates a cross-sectional view of an array of fluid pressure regulator devices, according to some embodiments.

FIG. 12 illustrates a block flow diagram of a method of using a fuel cell system, according to some embodiments.

FIG. 13 illustrates a perspective view of a fuel cell cover with features, according to the various embodiments.

### SUMMARY

The various embodiments relate to a fuel cell cover comprising an interface structure proximate to one or more fuel cells. The interface structure may affect one or more environmental conditions near or in contact with the one or more fuel cells.

The various embodiments relate to a fuel cell cover comprising an interface structure proximate to one or more fuel cells, wherein the cover may include one or more features to enhance the performance of the one or more fuel cells in a selected set of one or more environmental conditions.

The various embodiments also relate to a fuel cell cover comprising a cover in contact with one or more fuel cells. The cover may include one or more features that respond to a change in to one or more environmental conditions near or in contact with the one or more fuel cells in order to enhance the performance of the fuel cells.

The various embodiments may also relate to an electronic system comprising an electronic device, one or more fuel cells in contact with the electronic device and an adaptive interface structure. The cover may affect one or more environmental conditions near or in contact with the one or more fuel cells.

The various embodiments may relate to a method of making an electronic system comprising forming an electronic device, forming one or more fuel cells in contact with the electronic device, forming an interface structure, contacting the one or more fuel cells with the electronic device and contacting the cover with one or more of the fuel cells or electronic device.

### DETAILED DESCRIPTION

The following detailed description includes references to the accompanying drawings, which form a part of the detailed description. The drawings show, by way of illustration, various embodiments that may be practiced. These embodiments, which are also referred to herein as “examples,” are described in enough detail to enable those skilled in the art to practice the embodiments. The embodiments may be combined, other embodiments may be utilized, or structural, and logical changes may be made without departing from the scope of the various embodiments. The following detailed description is, therefore, not to be taken in a limiting sense, and the scope of the various embodiments is defined by the appended claims and their equivalents.

In this document, the terms “a” or “an” are used to include one or more than one and the term “or” is used to refer to a nonexclusive “or” unless otherwise indicated. In addition, it is understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

The various embodiments relate to a fuel cell cover. Performance of fuel cell systems, including passive fuel cell systems, may be affected by environmental conditions, such as humidity, ambient temperature, ambient pressure, or other environmental conditions. In order to get suitable performance out of an active area of a fuel cell, as well as substantially all of the fuel cells in a stack, or in a fuel cell layer, the reactants may be approximately evenly distributed across each active area and each cell uniformly. Fuel cells may utilize some form of gas diffusion layer (GDL) that is configured to achieve this. Larger fuel cells may employ a “bipolar plate” or a “separator” plate that defines flow fields to aid in this purpose. Due to the design of most fuel cell systems, the GDL and the bipolar plate (if employed) may be electrically conductive in order to collect the electrons generated in the fuel cell reaction. Consequently, this may limit the materials that may be used to fabricate a GDL in such a fuel cell. One suitable material is a form of carbon fiber paper, which is configured to be porous and electrically conductive.

In a fuel cell architecture where a generated current is collected on the edge of the cell, (instead of into a GDL and into an associated current-carrying structure), adaptability and interchangeability in fuel cell covers may be obtained. Examples of such fuel cells may be found in the commonly-owned U.S. patent application Ser. No. 11/047,560, which was filed on Feb. 2, 2005, entitled “ELECTROCHEMICAL CELLS HAVING CURRENT-CARRYING STRUCTURES UNDERLYING ELECTROCHEMICAL REACTION LAYERS,” published as U.S. Patent Application Publication 2005/0250004, and issued as U.S. Pat. No. 7,632,587, the disclosure of which is herein incorporated by reference.

Because the current carrying structures in such fuel cells are located at the edges of the fuel cells, planar fuel cell layers may utilize gas diffusion layers (GDL) that may not be electrically conductive. This feature may allow the use of interchangeable or adaptive covers, in accordance with the various embodiments, that may include materials and configurations not otherwise feasible for use in connection with as GDLs. Further, the various embodiments may also be utilized in conventional fuel cells with GDLs, as a feature to enhance the fuel cell performance in varying environmental conditions.

The covers according to the various embodiments may function to enable an oxidant, such as air, to contact the cathodes of the fuel cell. The material, structure, and other physical properties of the cover may affect the performance of the fuel cells. Performance of fuel cells may be affected by both environmental conditions proximal to the fuel cell, such as temperature, humidity and reactant distribution across the fuel cell, which may be affected by selection of a cover or gas diffusion layer.

The cover, according to the various embodiments, may include an interface structure that may be interchangeable or adaptable or both interchangeable and adaptable so that, in general terms, the cover is responsive to varying environmental conditions that may affect a fuel cell or fuel cell-powered electronic device. Interchangeable covers, which may be removably coupled to one or more fuel cells, may be configured to enhance the performance of the one or more fuel cells based on a set of selected environmental conditions. Adaptable covers may include one or more adaptive materials that are responsive to environmental conditions, such that the performance of the one or more fuel cells is therefore enhanced. The cover may be utilized with one or more fuel cells that may not require the cathode-environmental interface to be electrically conductive. Such fuel cells may utilize an integrated cathode, catalyst layer and current carriers, such that the interface or cover between the cathode and environment may not be electrically conductive in addition to maintaining the proper gas transport properties. The cover may therefore be used with passive, “air breathing” fuel cells, which do not actively control distribution of one or both reactants to the fuel cell layer.

In the various embodiments, where the gas diffusion layer may not be electrically conductive, the choice of material and structure is flexible to assist in altering the environment adjacent to the fuel cell or fuel cell-powered device. In addition, the cover may be utilized with an electrically conductive layer or be conductive itself, in order to function with conventional fuel cell systems. The cover may be configured to be customizable or adaptable based on structure, material or both. For example, the interchangeable or adaptable cover may affect temperature, humidity, pollutant or contaminant level in contact with the fuel cell. In the present disclosure, affecting an environmental condition proximate to a fuel cell may refer to increasing, decreasing, enhancing, regulating, controlling, or removing an environmental condition proximate to the cell.

In the various embodiments, the fuel cell cover may comprise a porous interface structure disposed on, or proximate to the reactive surface of the fuel cell layer, or it may be integrated into a conventional gas diffusion layer (GDL) of a fuel cell. The porous layer may be configured to employ an adaptable material. The porous layer may be configured to employ a thermo-responsive polymer. The polymer may include a plurality of pores. Adaptive materials included in the cover may be responsive to conditions external to the cover, conditions on or proximate to the fuel cells. Adaptive materials and structures may also include active control mechanisms, other stimuli, or any combination thereof. Some examples of conditions may include temperature, humidity, an electrical flow, or other conditions.

### DEFINITIONS

As used herein, “electrochemical array” may refer to an orderly grouping of electrochemical cells. The array may be planar or cylindrical, for example. The electrochemical cells may include fuel cells, such as edge-collected fuel cells. The electrochemical cells may include batteries. The electrochemical cells may be galvanic cells, electrolysers, electrolytic cells or combinations thereof. Examples of fuel cells include proton exchange membrane fuel cells, direct methanol fuel cells, alkaline fuel cells, phosphoric acid fuel cells, molten carbonate fuel cells, solid oxide fuel cells, or combinations thereof. The electrochemical cells may include metal-air cells, such as zinc air fuel cells, zinc air batteries, or a combination thereof.

As used herein, the term “flexible electrochemical layer” (or variants thereof) may include an electrochemical layer that is flexible in whole or in part, that may include, for example, an electrochemical layer having one or more rigid components integrated with one or more flexible components. A “flexible fuel cell layer” may refer to a layer comprising a plurality of fuel cells integrated into the layer.

The term “flexible two-dimensional (2-D) fuel cell array” may refer to a flexible sheet which is dimensionally thin in one direction, and which supports a number of fuel cells. The fuel cells may have active areas of one type (e.g., cathodes) that may be accessible from a first face of the sheet and active areas of another type (e.g., anodes) that are accessible from an opposing second face of the sheet. The active areas may be configured to lie within areas on respective faces of the sheet. For example, it is not necessary that the entire sheet be covered with active areas; however, the performance of a fuel cell may be increased by increasing its active area.

As used herein, “interface structure” or “interface layer” may refer to a fluidic interface configured to affect a local environment proximate to a fuel cell component, such as, for example, a fuel cell anode and/or a fuel cell cathode.

As used herein, “cover” may refer to an apparatus that encloses, or contacts, or is proximate to one or more fuel cells that includes an interface structure that is configured to affect an environmental condition proximate to the one or more fuel cells.

As used herein, “feature” may refer to an aspect of a fuel cell cover, which may be structured into the cover or may be an inherent property of a material used in the cover. Examples of features may include ports, holes, slots, mesh, porous materials, filters and labyrinth passages.

As used herein, “external environment” or “external conditions” or “environmental conditions” or “ambient environment” may refer to the atmospheric conditions in proximity to a cover or an interface structure, whether that environment resides inside or outside a device or housing. Accordingly, external conditions may include one or more of a temperature, a pressure, a humidity level, a pollutant level, a contaminant level, or other external conditions. “External environment” or “external conditions” or “environmental conditions” or “ambient environment” may also refer to more than one of a temperature, a pressure, a humidity level, a pollutant level, a contaminant level, or other external conditions in combination.

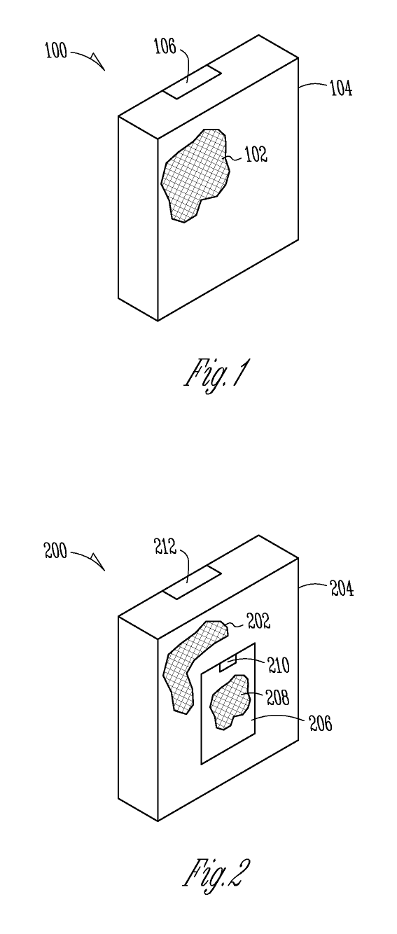

Referring to FIG. 1, a perspective view of a fuel cell cover 100 according to the various embodiments. The fuel cell cover 100 may include an interface structure 102, which may be structured into an enclosure 104, inherent in a material used to form the enclosure 104, or otherwise proximate to a fuel cell or a fuel cell layer. The fuel cell cover 100 may be partially or fully integrated with a surface of a fuel cell or a fuel cell layer. Suitable fuel cell structures, devices and systems may be found in the following commonly-owned U.S. patent applications: U.S. patent application Ser. No. 11/047,560, which was filed on Feb. 2, 2005, entitled “ELECTROCHEMICAL CELLS HAVING CURRENT-CARRYING STRUCTURES UNDERLYING ELECTROCHEMICAL REACTION LAYERS”, published as U.S. Patent Application Publication 2005/0250004, and issued as U.S. Pat. No. 7,632,587; U.S. patent application Ser. No. 11/327,516, which was filed on Jan. 9, 2006, entitled “FLEXIBLE FUEL CELL STRUCTURES HAVING EXTERNAL SUPPORT”, and published as U.S. Patent Application Publication 2006/0127734; U.S. patent application Ser. No. 11/185,755, which was filed Jul. 21, 2005, entitled “DEVICES POWERED BY CONFORMABLE FUEL CELLS”, published as U.S. Patent Application Publication 2007/0090786, and issued as U.S. Pat. No. 7,474,075; and U.S. patent application Ser. No. 12/238,241, which was filed on Sep. 25, 2008, entitled “FUEL CELL SYSTEMS INCLUDING SPACE-SAVING FLUID PLENUM AND RELATED METHODS”, which was filed Sep. 25, 2008, and published as U.S. Patent Application Publication 2009/0081493; all of which are herein incorporated by reference. For example, the cover 100 may include an interface layer that is positioned proximate to a fuel cell device. The interface structure 102 may extend across substantially an entire external surface of the enclosure 104, or it may extend across only a portion of the external surface of the enclosure 104. The interface structure 102 may be configured to enhance the performance of the one or more fuel cells (not shown) positioned within the enclosure 104 in a selected set of one or more environmental conditions. Accordingly, the interface structure 102 may include features such as ports, holes, slots, a mesh, a porous material, a filter network or any combination thereof. The interface structure 102 may also include an adaptive material, which will be described in greater detail below.

The interface structure 102 may be operable to exclude selected materials, such as atmospheric pollutants or excess water (e.g., humidity) in an external environment. The interface structure 102 may also be operable to admit selected materials, such as water, when the cover 100 is exposed to a dry external environment. The size, porosity and orientation of features in the interface structure 102 may be varied to affect the flow or to control a flow of a material to the fuel cell, depending on the desired conditions.

The interface structure 102 may be operable to affect one or more selected local environmental conditions. For example, the interface structure 102 may be incorporated into the enclosure 104 so that it is removable and may be changed to provide another interface structure 102 having different physical characteristics, which may depend on the environmental conditions present at the time of fuel cell operation. For example, one interface structure 102 may be configured for use in an environment which is hot and dry, such as a desert, while another interface structure 102 may be configured for use in an environment which is hot and wet, such as a rainforest. Still another interface structure 102 may be configured for use in an environment which is cool and wet; while another interface structure 102 may be configured for use in an environment which is cold and dry. The above examples illustrate possible variations for an interchangeable interface structure 102, depending on the ambient environment. Both the materials and the features that may be associated with the interface structure 102 may be selected and/or adapted to enable a fuel cell layer to operate over a wide range of environmental conditions. Although FIG. 1 shows the interface structure 102 disposed on a portion of the enclosure 104, it is understood that in the various embodiments, that the interface structure 102 and the enclosure 104 may be coincident structures, so that the entire enclosure 104 may constitute the interface structure 102, so that the foregoing interchangeability may extend to the entire fuel cell cover 100. It is also understood that in the various embodiments, the interface structure 102 may directly contact (or may be integrated into) the one or more fuel cells enclosed within the enclosure 104, or the interface structure 102 may be spaced apart from the one or more fuel cells enclosed within the enclosure 104. The one or more features in the interface structure 102 may respond to a change in to one or more environmental conditions near or in contact with the one or more fuel cells in order to enhance the performance of the fuel cells. The features may be incorporated into, or may be inherent to one or more adaptive materials.

The enclosure 104 may comprise materials such as paper, various polymers such as NYLON (manufactured by E. I. du Pont de Nemours and Company, Wilmington, Del.), and manufactured fibers in which the fiber forming substance is a long-chain synthetic polyamide in which less than 85% of the amide-linkages are attached directly (—CO—NH—) to two aliphatic groups), polytetrafluoroethylene (PTFE), polyvinylidene difluoride (PVDF), polyvinyl alcohol or polyethylene, for example. The enclosure 104 may comprise features that may be embodied in some combination of the above listed materials, one or more adaptive materials, or may be formed in the interface structure 102, for example.

The interface structure 102 may be comprised of adaptive materials that may physically or chemically respond to a change in one or more environmental conditions, which may include a temperature, a pressure (such as atmospheric pressure, the partial pressure of oxygen in air), a humidity, a pH level, various chemical compounds and/or light. Accordingly, the interface structure 102 may enhance the performance of the one or more fuel cells that may be positioned in the enclosure 104. Examples of suitable adaptive materials may include waxes, fibers or coatings, as disclosed, for example, in U.S. Pat. No. 4,708,812 to Hatfield, and entitled “ENCAPSULATION OF PHASE CHANGE MATERIALS”; U.S. Pat. No. 4,756,958 to Bryant, et al., entitled “FIBER WITH REVERSIBLE ENHANCED THERMAL STORAGE PROPERTIES AND FABRICS MADE THEREFROM”; and U.S. Pat. No. 6,514,362 to Zuckerman, et al., entitled “FABRIC WITH COATING CONTAINING ENERGY ABSORBING PHASE CHANGE MATERIAL AND METHOD OF MANUFACTURING SAME”; all of which are incorporated herein by reference. Other suitable adaptive materials may include various shape memory polymers (SMP), as disclosed, for example, in U.S. Pat. No. 6,627,673 to Topolkaraev, et al., and entitled “METHODS OF MAKING HUMIDITY ACTIVATED MATERIALS HAVING SHAPE MEMORY”, which is also incorporated herein by reference.

Shape memory polymers may be stimulated by a temperature, a pH level, various chemical compounds, and/or light. In general, shape memory polymers are polymer materials configured to sense and respond to external stimuli in a predetermined manner. Additional examples of suitable shape memory polymers are any of the polyurethane-based thermoplastic polymers (SMPUs). Such materials demonstrate a shape memory effect that is temperature-stimulated based on the glass transition temperature of the polymer (which may be between approximately −30 C and +65 C). Fibers made from SMPs may be used to make shape memory fabrics and textiles, such as an aqueous SMPU. Another example of a suitable SMP may include a polyethylene/NYLON-66 graft copolymer.

SMPs may be suitably configured so that physical properties, such as water vapor permeability, air permeability, volume expansivity, elastic modulus, and refractive index may vary above and below the glass transition temperature. SMPs used to control water vapor permeability may include elastomeric, segmented block copolymers, such as polyether amide elastomer or polyurethane elastomer.

Shape memory alloys (SMA) are a further example of materials which may be utilized in an interface structure 102, in accordance with the various embodiments. One or more SMA may be used, for example, to configure a pore size in the interface structure 102 in response to an environmental condition, such as temperature, humidity or other physical stimuli. Multiple SMAs with multiple transition temperatures may be used to provide environmental adaptability over a range of temperatures. For example, at least two SMAs with differing transition temperatures may cooperatively form actuators that provide environmental adaptability. Accordingly, as the temperature rises, the interface structure 102, including the SMA actuators is heated. When a transition temperature of the first SMA actuator is reached, the SMA actuator contracts to reduce air access to the cathodes. As the temperature increases still further, the transition temperature of the second SMA actuator may be reached, resulting in the second SMA actuator contracting and further reducing the air access to the cathodes. Alternatively, the SMA actuators may be configured to be controlled by a current applied across the SMA actuator, which may be applied, for example, in response to an applied signal.

Thermoresponsive polymers that exhibit positive swelling behavior with an increase in temperature may be used. One such material is described in the paper “Synthesis and Swelling Characteristics of pH and Thermoresponsive Interpenetrating Polymer Network Hydro gel Composed of Poly(vinyl alcohol) and Poly(acrylic acid), authored by Young Moo Lee, et al. (Journal of Applied Polymer Science 1996, Vol. 62, 301 311). In addition to the thermoresponsive materials exhibiting positive swelling, thermoresponsive polymers with negative swelling may also be used. When using materials with negative swelling behavior, a boundary condition of the material layer may be such as to allow the pores to shrink with an increase in temperature. A combination of materials exhibiting positive and negative swelling may also be used to realize variable porosity behavior of the GDL. Additional materials that exhibit variable porosity behavior are described in “Separation of Organic Substances with Thermoresponsive Polymer Hydrogel” by Hisao Ichijo, et al. (Polymer Gels and Networks 2, 1994, 315 322 Elsevier Science Limited), and “Novel Thin Film with Cylindrical Nanopores That Open and Close Depending on Temperature: First Successful Synthesis”, authored by Masaru Yoshida, et.al. (Macromolecules 1996, 29, 8987 8989).

In accordance with the various embodiments, a property of an adaptable material may be varied in response to an environmental condition in proximity to the electrochemical cells of the array. The property of the adaptable material may include its porosity, hydrophobicity, hydrophillicity, thermal conductivity, electrical conductivity, resistivity, overall material shape or structure, for example. The environmental conditions may include one or more of a temperature, humidity, or environmental contaminants level.

In accordance with the various embodiments, a property may also be varied in response to an applied signal, for example. The adaptive material may be heated in response to the signal. For example, by heating the adaptive material, one or more of the adaptive material properties may be varied. The performance of the electrochemical cell array may also be determined periodically or continuously monitored. Examples thermo-responsive adaptable materials are described in U.S. Pat. No. 6,699,611, filed May 29, 2001, entitled “FUEL CELL HAVING A THERMO-RESPONSIVE POLYMER INCORPORATED THEREIN,” and U.S. Pat. No. 7,132,192 to Muthuswamy, et. al, entitled “FUEL CELL USING VARIABLE POROSITY GAS DIFFUSION MATERIAL”, the disclosure of which is incorporated herein.

Other examples of adaptive materials may include woven materials having fibers or ribbons which may increase in length as humidity increases, therefore increasing the porosity of the weave and increasing air access to the cathodes of the fuel cells. Conversely, the fibres shorten when humidity decreases, thereby decreasing the porosity of the weave and decreasing air access to the cathodes, enabling the membrane to self-humidify.

In the various embodiments, the interface structure 102 may be adaptable using a mechanical means, such as a louvre or a port having a variable aperture. Such mechanical adaptations may be accomplished automatically in response to an applied signal, such as from a sensor, or by a manual input.

The fuel cell cover 100 may also optionally include an attachment mechanism 106 that is suitably configured to physically and/or electrically couple to an external electronic device. The attachment mechanism 106 may be a clip, a lock, a snap or other suitable attachment devices.

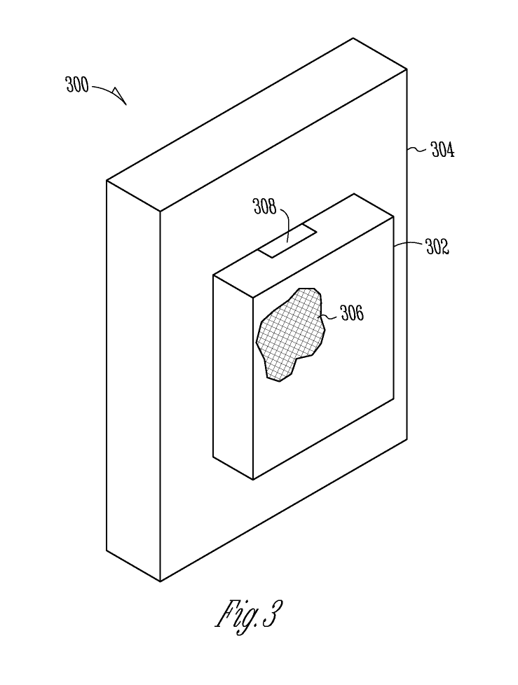

Referring to FIG. 2, a perspective view of a fuel cell cover 200 is shown, according to the various embodiments. The fuel cell cover 200 may include a first interface structure 202 that is formed on at least a portion of an external surface of an enclosure 204. The fuel cell cover 200 may also include a removable access plate 206 that permits access to an interior portion of the enclosure 204. The access plate 206 may include a second interface structure 208 having different properties (e.g., a different porosity, material or response characteristic to an environmental condition, such as a second adaptive material) than the first interface structure 202. Accordingly, in the various embodiments, the removable access plate 206 may be interchanged with other access plates 206 having different characteristics, so that the environmental conditions proximate to the fuel cells within the enclosure 204 may be “fine-tuned”. The access plate 206 may thus allow customization of the cover 200, since interchangeable materials, meshes, porous materials, screens, vents or filters may be utilized. Optional attachment mechanisms 210 and 212 may be included that may be configured to couple the access plate 206 to the enclosure 204, and to couple the enclosure 204 to an electronic device, respectively.

The cover 200, or portions thereof, may be manufactured of an adaptive material, and the removable access plate 206 may be configured to take into account a set of selected environmental conditions, and may include features to enable optimized performance under such conditions. Such an arrangement allows the cover 200 to have adaptive and interchangeable capabilities. In addition, it is understood that the foregoing optimization may be accomplished where the cover 200 and/or the interface structure are interchangeable.

Alternatively, the cover 200, its features, materials, or components may be adaptable or may be optimized for a given set of environmental conditions. Depending on the environmental conditions, it may be configured to allow more or less oxidant to access the cathodes of the fuel cell layer. For example, under hot and/or dry conditions, an ion exchange membrane of a fuel cell may be subject to drying out. Under such environmental conditions, the cover 200 (and/or the first interface structure 202 and the second interface structure 208) may be configured to reduce air flow to the cathodes, to increase the ability of the ion exchange membrane to self-humidify. In contrast, under environmental conditions that include high levels of humidity, the ion exchange membrane may be prone to flooding, and therefore the cover 200 may be configured to increase air flow to the cathodes, for example by increasing the pore size of an adaptive material comprising the first interface structure 202 and the second interface structure 208, or utilizing a more porous first interface structure 202 and/or second interface structure 208. In the various embodiments, it is understood that the second interface structure 208 may be optional.

The fuel cell cover 200 (and/or the first interface structure 202 and the second interface structure 208) may affect both in-plane and through-plane conductivity and mobility of both reactants and products of the electrochemical reaction. For example, in the various embodiments, in-plane distribution of product water may be promoted across a fuel cell layer to provide even humidification of the ion-exchange membrane across the fuel cells, in addition to enabling balanced evaporation from a fuel cell system.

Further, in the various embodiments, the various attributes of the fuel cell cover 200 discussed above may be configured to be distributed in a non-uniform and/or asymmetric fashion across fuel cell layers. For example, and in accordance with the various embodiments, features (e.g., holes, perforations, or other openings) closer to the edge of the active area of a fuel cell may have a relatively higher or lower porosity compared to features closer to the center of the active area of a fuel cell. Properties of the features may be varied to increase or decrease air access to the cell depending on the position relatively to the cell geometry. FIG. 13 illustrates cover 2000 where features (e.g., holes, perforations, or other openings) in first area 2002 have a relatively higher or lower porosity compared to features in second area 2003, wherein the features of first area 2002 are closer to the edge of an active area of a fuel cell while the features of second area 2003 are closer to the center of the active area of a fuel cell. Collectively, first area 2002 and second area 2003 form a non-uniform active area.

In the various embodiments, aspects of the cover 200 may be exchangeable or disposable. For example, the cover 200 may comprise a filter element, which may be disposable. A filter may be used in environments where there may be excess levels of pollutants or contamination to prevent such pollutants from reaching the cathodes of the fuel cell layer. The filter may be configured to be field-replaceable at the discretion of the user of the portable electronic device, or as necessary. In the various embodiments, the filter may be incorporated into or accessible via the removable access plate 206.

Referring to FIG. 3, a perspective view of an electronic system 300 according to the various embodiments. The electronic system 300 may include a fuel cell cover 302, which may include, for example, any of the embodiments disclosed in connection with FIG. 1 and FIG. 2. An electronic device 304 may be in contact with a fuel cell cover 302. The electronic device 304 may be configured to be removably engaged to the fuel cell cover 302. The fuel cell cover 302 may include one or more interface structures 306, as previously described. An optional attachment mechanism 308 may be configured to couple the fuel cell cover 302 to the electronic device 304.

The electronic device 304 may include a cellular phone, a satellite phone, a PDA, a laptop computer, an ultra mobile personal computer, a computer accessory, a display, a personal audio or video player, a medical device, a television, a transmitter, a receiver, a lighting device, a flashlight, a battery charger, a portable power source, or an electronic toy, for example. The cover 302 may contain all or part of a fuel cell or a fuel cell system, including a fuel enclosure, for example. The cover 302 alternatively may contain no components of the fuel cell system, as will be described in greater detail below.

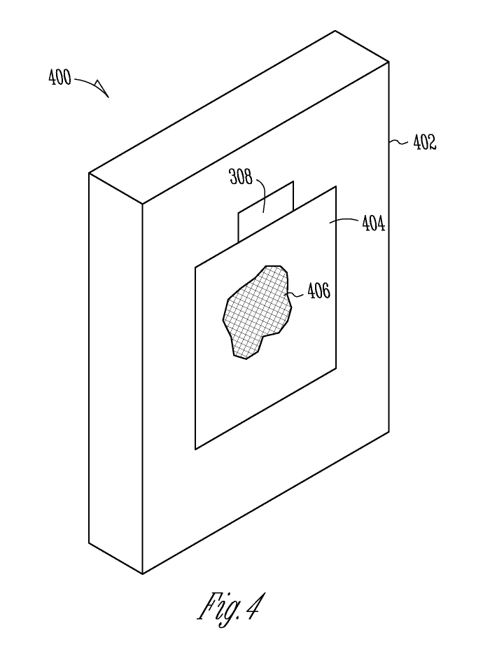

Referring now to FIG. 4, a perspective view of an electronic system 400 according to the various embodiments. The electronic system 400 may include an electronic device 402 that may further include fuel cell cover 404 that may optionally be substantially flush with a surface of the electronic device 402. The cover 404 may include one or more interface structures 406, as previously described, and an optional attachment mechanism 308 to couple the cover 404 to the electronic device 402. The cover 404 may be flush or substantially flush with the electronic device 402, so that little to no exterior profile of the cover 404 protrudes from a face of the electronic device 402.

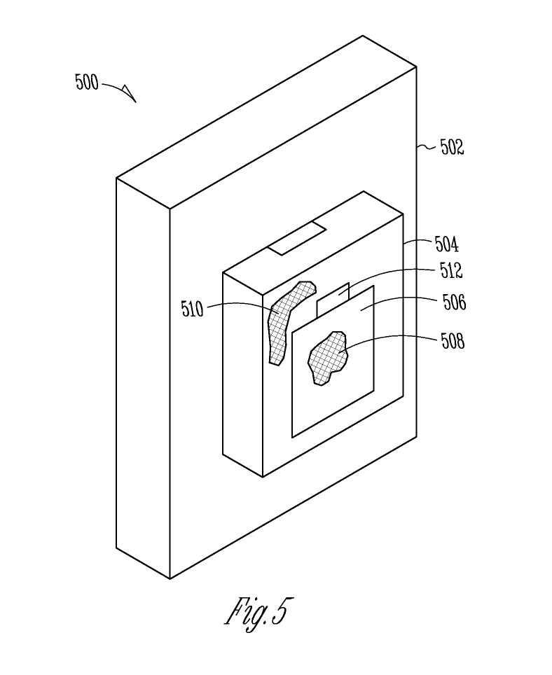

Referring to FIG. 5, a perspective view of an electronic system 500 is shown, according to the various embodiments. The electronic system 500 may include an electronic device 502 that may be operably coupled to a fuel cell cover 504. The cover 504 may include a removable access plate 506 that may further include one or more interface structures 508 and an optional attachment mechanism 512. The cover 504 may also include one or more interface structures 510. The cover 504 may be interchangeable, and the access plate 506 may also be interchangeable, therefore increasing the ability to adjust the environmental conditions near or in contact with a fuel cell enclosed within the cover 504.

Referring to FIG. 6, an exploded view of an electronic system 600 is shown, according to the various embodiments. The system 600 may include an electronic device 602 that may further include a recess 604 configured to receive one or more fuel cell layers 606, and, optionally, one or more fuel cartridges, fluidics, power conditioning, or combinations thereof, which may be operably coupled to the fuel cell layers. The fuel cell layers 606 may therefore be operably coupled to the electronic device 602. A fuel cell cover 608 may be positioned on the electronic device 602 or may be positioned on the fuel cell layers 606. The fuel cell cover 608 may include one or more interface structures 610, as previously described. Attachments 612 may also optionally couple the cover 608 to the electronic device 602. In such cases, the combination of the fuel cell layers, fuel cell cover, and optionally other aspects (e.g. fuel cartridge, fluid manifolding, valves, pressure regulators, etc) may form a fuel cell system, which may then be coupled as a fuel cell system to the electronic device.

The covers described herein may be used with fuel cell systems that have a fluid supply system with reduced volumetric requirements but which are able to supply fuel or other reactant fluid to the anode or anodes of a fuel cell at an acceptable pressure level and in a uniform manner. The systems may include a deformable enclosed region located between fluid control elements and the fuel cell which allows fuel to be supplied to the anode or anodes at an acceptable pressure level and delivery rate, while allowing for a more compact fuel cell system.

In one example, the covers described herein can be used with a fuel cell system that includes a fluid manifold having first and second sides, at least one manifold outlet in the first side, and a manifold inlet fluidly coupled to the manifold outlet via a fluid directing recess located within the fluid manifold, a fuel cell layer including at least one fuel cell wherein a portion of the fuel cell layer is bonded to the first side of the fluid manifold (such as peripherally bonded), and an enclosed region formed by the bonded fuel cell layer and the fluid manifold.

Initially (e.g. immediately after manufacture), the enclosed region may be essentially volumeless with the fuel cell layer adjacent to the first major side of a substrate, such as a fluid manifold. However, the fuel cell layer, the fluid manifold, or both may be flexible in whole or in part and thus may be deformed under application of modest pressure, or may include inherent material properties, such as elasticity, which enable the components to adapt in response to an imparted stress. Thus, one or more portions of the fuel cell layer or the fluid manifold may deform away from each other when the enclosed region is pressurized by fluid (e.g. fuel) from the manifold outlet. This transforms the enclosed region from being substantially volumeless into a region with sufficient volume to serve as a fluid distribution plenum for the fuel cell layer. Alternately, a stress imparted by the introduction of a pressurized fluid may result in the adaptation or modification of the fuel cell layer, a portion thereof, or the fluid manifold sufficient to transform the enclosed region, either chemically or physically, into a fluid plenum, such as a fuel plenum. If the fluid pressure is reduced again (e.g. after prolonged shutdown), the plenum may collapse in whole or in part depending on how elastic the components are. However, upon reapplication of fluid pressure, the enclosed region once again may inflate or otherwise transform sufficiently to serve as a fluid plenum.

These described fuel cell systems and methods therefore have reduced volumetric requirements. Further, while the fuel cell system may additionally employ external supports or fixtures to support the fluid plenum formed between the fuel cell layer and fluid manifold, external supports or fixtures are not necessary. The flexible fuel cell layer and/or flexible fluid manifold are thus “self-supported”components, that is no external supports or fixturing are required for their function. Such “self-supported” flexible fuel cell layers are useful not only in the fabrication of systems in which there is initially no fluid plenum but they can be useful in other systems as well.

In an example, a distance between the fluid manifold outlet side and the fuel cell layer at a non-pressurized enclosed region state is approximately equal to a cross-sectional thickness of a bond member. In another example, the fluid manifold and the fuel cell layer have a combined cross-sectional thickness of about 5 mm or less, about 1 mm or less, or about 0.6 mm or less at a non-pressurized enclosed region state.

Among other things, these systems and methods provide for fuel cell systems occupying less volume or a smaller footprint of an electronic component or device into which they are installed, while still meeting the power demands of the component or device. These fuel cell systems and methods include a space-saving fluid plenum transformable from a substantially volumeless enclosed region and in this way, allows for the creation of smaller, more compact fuel cell systems configurable to fit within an existing electronic device. The enclosed region may be located between a substrate (i.e., fluid manifold) and at least one fuel cell layer. In an example, the enclosed region may be formed by a peripheral-type of coupling between an outlet side of the fluid manifold and the fuel cell layer via suitable bonding means (e.g. a bond member). In varying examples, the enclosed region transforms into a fluid plenum when a fluid exiting the fluid manifold pressurizes the enclosed region causing one or more portions of the fuel cell layer and/or the fluid manifold to deform away from each other. In an example, a distance between the outlet side of the fluid manifold and the fuel cell layer at a non-pressurized enclosed region state is approximately equal to a cross-sectional thickness of a bond member. In another example, the cross-sectional thickness of the bond member is about 0.05 mm or less. In another example, the cross-sectional thickness of the bond member is about 1 mm or less, or about 0.2 mm or less. As will be discussed below, the space-saving fluid plenum can be used in conjunction with other fuel cell components, such as a fluid reservoir, a fluid pressure regulator device(s), a fluid manifold, a bond member, a fuel cell, and an optional external support structure, to create a compact fuel cell system.

As used herein, “self-supported” refers to an electrochemical cell layer if, when coupled to a substrate, no external fixturing is required to create and/or maintain the integrity of a fuel plenum when in use.

As used herein, “adjacent” or “adjacently”, when used in the context of the fuel cell layer being adjacent to the fluid manifold, refers to a fuel cell layer is close enough proximity to the fluid manifold such that the enclosed region is too small to effectively function as a fluid distribution plenum.

As used herein, “bonding member” refers to an implicit or explicit component that facilitates the coupling of two objects. In an example, an implicit bonding member may include an adhesive or weld. An explicit bonding member may include a mechanical fastener, for example.

As used herein, “substrate” refers to a component coupled to an electrochemical cell layer, sufficient to create an enclosed space. A substrate may include, among other things, a fluid manifold, a fuel cell system structural member, fluidic control components, fluid reservoir, a portion of an electronic device or a combination thereof. Fluidic control components may include pressure regulator devices, such as an array of regulators, for example.

As used herein, “deform” or “deformation” refers to in general, the behaviour of a material, component, structure, or composite layer in response to an imparted stress. A deformation may be an intended result, or it may be an unintended side effect. A deformation may be of a large enough magnitude to be clearly visible to the naked eye (e.g on the order of millimeters), or may be small enough that it can only be detected with the aide of a microscope (e.g. on the order of micrometers or nanometers). A deformation may comprise the ‘flexing’ or ‘bending’ of a component, or may alternately comprise compression or other such change in shape of a component.

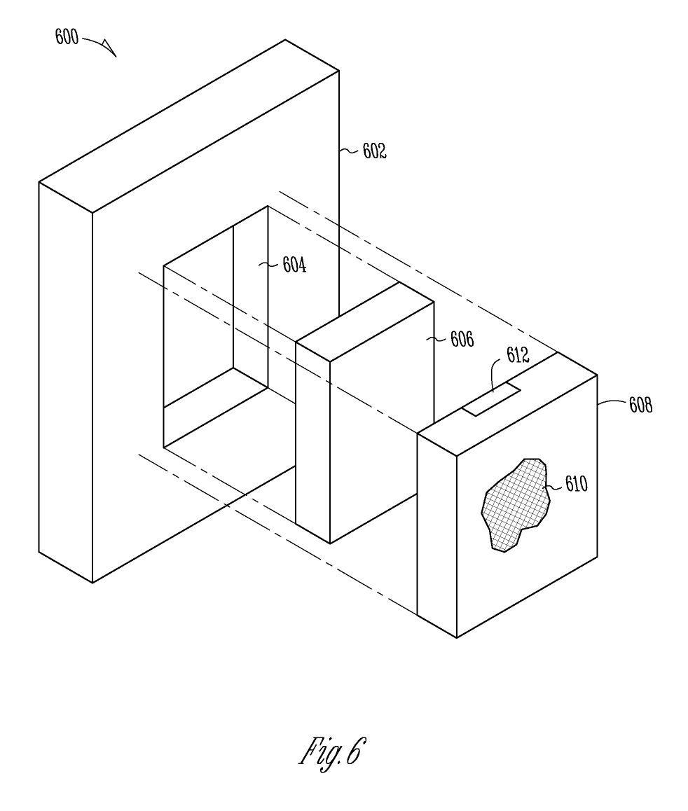

FIG. 7 illustrates a fuel cell system that may be used with the covers described herein. FIG. 7 illustrates an exploded view of a fuel cell system 1100 comprising, but not limited to, a fluid reservoir 1102, an optional fluid pressure regulator assembly 1104 including multiple fluid pressure regulator devices 1126, a manifold sealing layer 1106, a manifold conduit layer 1108, a bond member 1110, a fuel cell layer 1112, and an external support structure 1114. The fluid reservoir 1102 provides fuel or other reactant fluid for the fuel cell system 1100 and can be charged or refueled via a charge port 1116. In an example, the fluid reservoir 1102 can comprise a cellular fuel tank, such as is discussed in commonly-owned Zimmermann, U.S. patent application Ser. No. 11/621,501, entitled “CELLULAR RESERVOIR AND METHODS RELATED THERETO,” (now issued as U.S. Pat. No. 8,227,144) or other fluid enclosure as is discussed in commonly-owned Zimmermann, U.S. patent application Ser. No. 11/473,591, entitled “FLUID ENCLOSURE AND METHODS RELATED THERETO” (now issued as U.S. Pat. No. 7,563,305).

A fluid manifold, which may optionally include one or more of the fluid pressure regulator assembly 1104, the manifold sealing layer 1106, and the manifold conduit layer 1108 provides for the distribution, regulation, and transfer of fuel from the fluid reservoir 1102 to the fuel cell layer 1112. In this example, the fluid pressure regulator assembly 1104 controls the fuel pressure coming out of the fluid reservoir 1102 by reducing a primary (higher) fluid pressure present therein to a more constant secondary (lower) fluid pressure for delivery to the fuel cell layer 1112. A fluid manifold, including the manifold sealing layer 1106, the manifold conduit layer 1108, and the fluid pressure regulator assembly 1104, is fluidly coupled to the fuel cell layer 1112 via a material directing recess 1120. The material directing recess 1120 of the fluid manifold directs the flow of fuel from the fluid pressure regulator assembly 1104 to a region adjacent to the fuel cell layer 1112, and can be formed by creating one or more channels in the manifold conduit layer 1108, for example. In an example, the fluid manifold includes a layered structure that allows for the manifold to be of a size that does not take up unnecessary volume, nor an unnecessarily large footprint, yet allows for the pressure, volume, or temperature requirements for fuel cell systems 1100 to be met, as is discussed in commonly-owned Schrooten et al., U.S. patent application Ser. No. 12/053,366, entitled “FLUID MANIFOLD AND METHODS THEREFOR” and published as U.S. Patent Application Publication 2008/0311458.

The fuel cell layer 1112 includes fuel cell layers (i.e., comprising at least one anode and cathode) with an electrolyte interposed therebetween. In an example, the fuel cell layer 1112 utilized in the system 1100 can be planar, as is discussed in commonly-owned McLean et al., U.S. patent application Ser. No. 11/047,560, entitled “ELECTROCHEMICAL CELLS HAVING CURRENT-CARRYING STRUCTURES UNDERLYING ELECTROCHEMICAL REACTION LAYERS” (now issued as U.S. Pat. No. 7,632,587). In such an example, an electric current-carrying structure that collects power generated by the fuel cell layer 1112 underlies, at least in part, one of the fuel cell layers.

Either the fuel cell layer or the fluid manifold is flexible such that it can be deformed under pressure. In such an example, one or more fuel cells are substantially integrated within a flexible electrochemical layer. The flexible electrochemical layer may optionally include one or more rigid components, and thus, may not be flexible in its entirety. In operation of the fuel cell system 1100, the anode of each cell receives the fuel from the fluid reservoir 1102 and the cathode of each cell receives air containing oxygen as an oxidizing agent via one or more air access ports 1118 in the external support structure 1114, for example.

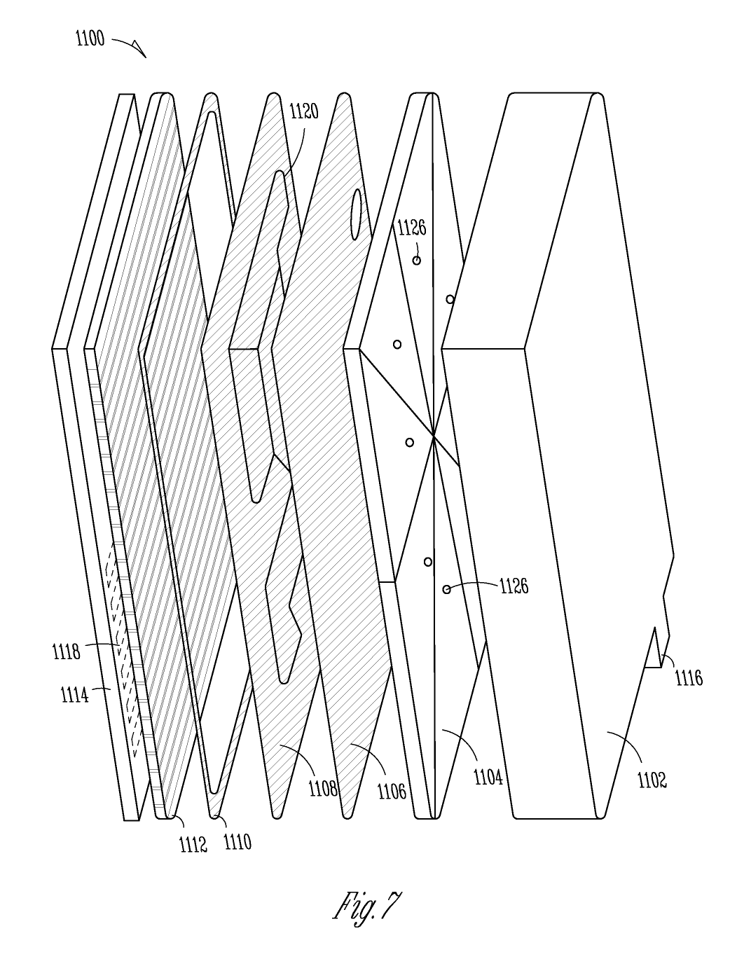

FIG. 8 illustrates a cross-sectional view of portions of the fuel cell system 1100, including fluid manifold 1202, bond member 1110, and fuel cell layer 1112. The fuel cell layer 1112 is coupled with portions of fluid manifold 1202 via bond member 1110, and in this way, creates one or more enclosed regions 1208 therebetween. Bond member 1110 can include any physical or chemical means, such as protrusions or at least one of an adhesive member, a weld member, a solder member, a braze member, or a mechanical fastener. For instance, bond member 1110 can be a structural thermoset epoxy adhesive that may be cured under appropriate conditions of heat, pressure, or combinations thereof to create the bond between fluid manifold 1202 and fuel cell layer 1112. Heating and pressing may be done simultaneously or sequentially. In an example, enclosed region 1208 has a thickness that is approximately equal to a cross-sectional thickness of bond member 1110, such as about 0.05 mm or less. In another example, fluid manifold 1202 and fuel cell layer 1112 have a combined cross-sectional thickness of about 5 mm or less, 1 mm or less, or 0.6 mm or less.

As shown, fluid manifold 1202 may include a material directing recess 1120 extending therethrough. Each material directing recess 1120 receives, at an input 1204, fuel flow 1220 from fluid reservoir 1102 (FIG. 7) and provides, at an output 1206, fuel flow 1220 to the enclosed region 1208. In an example, the fuel flow includes at least one of hydrogen, methanol, formic acid, butane, borohydride compounds (including sodium and potassium borohydride), or liquid organic hydrogen carriers. The continuing receipt of fuel flow 1220 to the enclosed region 1208 causes portions of fuel cell layer 1112 to deform from a position adjacent the fluid manifold 1202, thereby forming fluid plenum 1210. Fluid plenum 1210 is sufficient in size to serve as a fuel distribution plenum for the fuels cells incorporated in fuel cell layer 1112. In operation, fluid reservoir 1102 (FIG. 7) is filled with fuel by pressurizing the charge port 1116 (FIG. 7). Fluid pressure regulator assembly 1104, including an array of fluid pressure regulator devices 1126 (FIG. 7), can be used to reduce or maintain a pressure in fluid plenum 1210 to a level sufficient for the operation and movement of the fuel cells in fuel cell layer 1112, such as to the position shown in phantom. In an example, a distance between fluid manifold 1202 and the fuel cell layer 1112 is about 5 mm or less at the pressurized plenum state. In some embodiments, a distance between fluid manifold 1202 and the fuel cell layer 1112 may be substantially the same in the pressurized plenum state as in the unpressurized plenum state, where deformation of the fuel cell layer may be very small. In some embodiments, such as when the system includes internal supports, portions of the fuel cell layer may deform sufficient to transform the enclosed space into a fluid plenum while some portions may remain stationary.

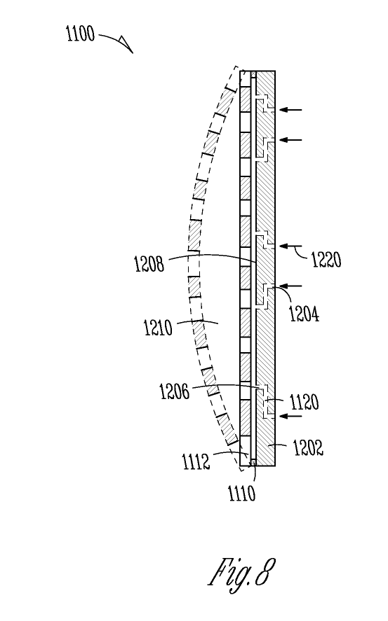

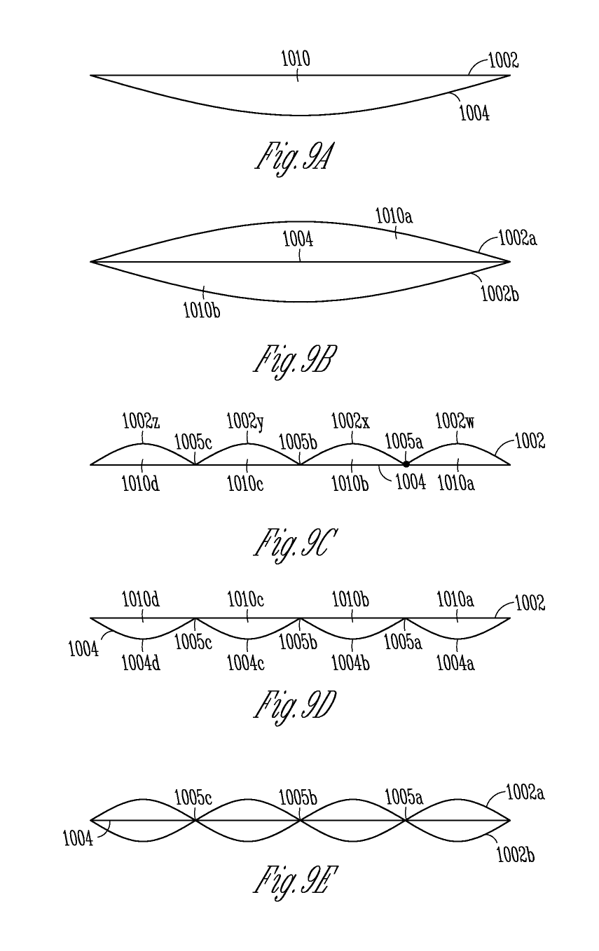

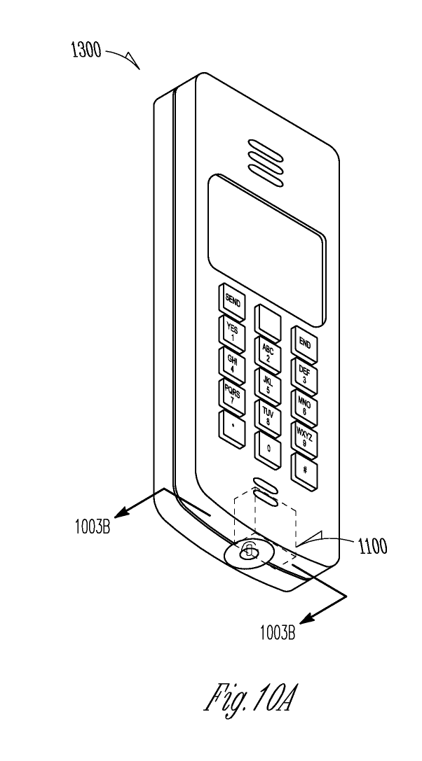

FIGS. 9A-9E illustrate cross-sectional views of in which either the fuel cell layer or the fluid manifold or both deform to create a fluid plenum when the enclosed region is pressurized. In FIG. 9A, fluid manifold 1004 is a flexible component and fuel cell layer 1002 is relatively rigid. When fluid is admitted to the enclosed region in between, fluid plenum 1010 is created. (Compare this embodiment to that in FIG. 8 in which fuel cell layer 1112 is flexible and fluid manifold 1202 is relatively rigid.) FIG. 9B shows yet another alternative in which the system comprises two flexible components. In FIG. 9B, there are two flexible fuel cell layers 1002a, 1002b bonded to fluid manifold 1004. Upon pressurizing the enclosed regions therebetween, two fluid plenums 1010a, 1010b are formed.

FIGS. 9C-9E show yet further alternatives comprising internal supports such as bond members, spacers, collapsible columns, combination thereof, or the like, that are intended to at least restrict the outward expansion of the flexible layers in the assembly. The reason for this is that during any movement, the flexible layers may change position or move outwardly and the risk of rupture increases. This approach may prevent such ruptures. One or more internal supports may collapse or expand in response to movement in the flexible layer. Referring to FIG. 9C, a cross sectional view of an embodiment comprising flexible fuel cell layer 1002, relatively rigid fluid manifold 1004, and internal supports is shown. One or more internal supports or bonds 1005a-1005c may be part of a gas management system, whose function may be, in part, to structurally support flexible fuel cell layer 1002 during any movement thereof (One example of movement may be a result of the pressurization and de-pressurization of a plenum in spaces 1010a-1010d.) As shown in FIG. 9C, fuel cell layer 1002 is bonded at support sites (e.g, the internal supports or bonds 1005a-1005c) to fluid manifold 1004. In particular, the support sites (e.g., the internal supports or bonds 1005a-1005c) can be configured to align with one or more current collectors of the fuel cell layer and may employ a conductive epoxy adhesive in order to bond fluid manifold 1004 to fuel cell layer 1002. The conductive epoxy adhesive may be cured under appropriate conditions of heat, pressure, or combinations thereof. Heating and pressing may be done simultaneously or sequentially. The conductive epoxy may serve as part of the current collection system in the fuel cell and may be integral with fluid manifold 1004, or may be in electrical contact with an electrically conductive portion of fluid manifold 1004. As a result, a series of plenums 1010-1010d are formed by portions 1002w-1002z of fuel cell layer 1002 as they inflated with pressurizing fluid. In some embodiments, portions of the fuel cell layer may be directly bonded or attached to the fluid manifold, for example by way of an adhesive member. In embodiments such as that shown in FIG. 9C, any deformation of the fuel cell layer may be extremely small, or almost imperceptible. For example, if the distance between subsequent bond members is sufficiently small, the unsupported area of the flexible fuel cell layer may also be small, and therefore the layer may not noticeably deform when the system is pressurized with a fluid.

FIG. 9D shows an embodiment equivalent to that shown in FIG. 9C except that here, fluid manifold 1004 is a flexible component and fuel cell layer 1002 is relatively rigid. Again, the internal supports or bonds 1005a-1005c are made between fuel cell layer 1002 and fluid manifold 1004 thereby creating a series of enclosed regions. As before, these regions are transformed, via deformation of portions 1004a-1004d of fluid manifold 1004, to become a series of fluid plenums 1010a-1010d when fluid pressure is admitted to the enclosed regions.

FIG. 9E shows yet another alternative with internal supports (bonds) in which the system comprises two flexible components. In FIG. 9E, there are two flexible fuel cell layers 1002a, 1002b bonded to fluid manifold 1004 at the periphery and at several internal locations (e.g., at the internal supports or bonds 1005a-1005c). Again, this forms a series of enclosed regions which, when pressurized with fluid, are transformed into numerous fluid plenums. (Note: in FIG. 9E, certain identifying indicia present in the preceding Figures have been omitted for purposes of avoiding clutter.)

The flexibility of the system allows for fuel cell placement and utilization in spaces and sizes not previously practical. The fuel cell system may conform with or within the structure of the device to which it provides power. The fuel cell layer or fuel cells may be manufactured in a planar configuration, but then be bent, twisted or otherwise conformed to a non-planar configuration for positioning and/or use. The layer or layers may move during operation or remain unchanged in position during operation. The flexible fuel cell layer may be manufactured in a planar form, but then positioned in a non-planar configuration.

The fuel cells described herein may be incorporated into the structure of any device which is powered, either in part or completely, by a fuel cell system. The systems described herein reduce the intrusion of the fuel cells within the envelope of the device being powered. This permits portable electrically-powered devices to be made more compact and/or permits the volume within the housing of a portable electronic device that would otherwise be occupied by batteries or another electrical power source to be used for other purposes.

A flexible fuel cell may include flexible layers, such as first and second flexible layers. The flexible layers may be contacted by one or more bond members and there may be a space in between. The fuel cell layer may be coupled to a substrate, creating an enclosed space. The fuel cell layer may be positioned in a planar or non-planar configuration and be operable in such a self-supported position.

The flexible layers include one or more fuel cells which may be thin-layer fuel cells or planar fuel cells in a two-dimensional array, for example. The fuel cells may be substantially integrated into the layer, such that the fuel cells are nearly or fully within the dimensions of the layer, for example. The flexible fuel cell layer may also include additional fuel cell components, such as current collection components. The current collection components may be in contact with two or more fuel cells present in the layer or layers. The current collection components may be substantially integrated within the layer, for example. In addition, fluidic control components may be integrated into the layer as well, such as pressure regulator devices. One or more fluid pressure regulator devices may be integrated and include an array of co-planar fluid pressure regulator devices, each fluidic pressure regulator device acting independently from the others.

The one or more fuel cells may form an array made up of individual fuel cells that are arranged two-dimensionally in any of various suitable ways on an area covered by the array. For example, cathode regions of individual fuel cells may be arranged to provide one or more of: one or two or more columns of substantially parallel stripes; shapes distributed at nodes of a two-dimensional lattice configuration (which could be a rectangular, square, triangular or hexagonal lattice, for example and which is not necessarily completely regular); a pattern of shapes distributed in both a width and a length dimension of the area covered by the array (such a pattern may be less regular than a lattice-type pattern), for example.

Thin layer fuel cells may be arranged into bipolar or unipolar arrays constructed of very thin layers. Within such an array, individual unit fuel cells may be connected in a series or series-parallel arrangement. Connecting fuel cells in such an arrangement permits electrical power to be delivered from an array of fuel cells at increased voltages and reduced currents. This, in turn, permits electrical conductors having smaller cross-sectional areas to be used to collect the electrical current.

For example, in some embodiments, individual unit fuel cells each produce electrical current at a voltage of less than 1 volt (typically about 0.6 volts) and enough individual fuel cells are connected in series within the array of fuel cells to produce an output voltage in excess of 6, 12, 48 or more volts. Providing output at higher voltages can be important because the electrical power produced by an array of fuel cells scales approximately with the area of the array. Therefore, for output at a fixed voltage, the current being supplied when the array of fuel cells is delivering its rated output power increases rapidly with the dimensions of the fuel cell array. Large and heavy conductors would be required to carry significant amounts of electrical power at the low output voltages provided by conventional unit fuel cells.

A further feature of some thin layer fuel cells is that the thin layer fuel cells can include current collecting conductors that are embedded within the fuel cell layers themselves. This reduces or avoids the need to provide current collecting conductors external to the thin layer fuel cells.

Conventional fuel cell stacks may require internal plumbing to carry air and oxidant to each unit fuel cell, but the thin layer fuel cells may provide arrays of unit fuel cells that do not require any special plumbing to allow air to contact the cathodes of the fuel cells. The unit fuel cells are arranged so that oxygen from ambient air present on one side of the array of fuel cells can readily contact cathodes of the unit cells. Thin layer fuel cells may comprise arrays of individual unit fuel cells that are organized in geometrical arrangements over a 2D surface. On one side of the surface, cathodes of the unit fuel cells are exposed at different locations on the surface for contact with an oxidant, such as air.

These thin layers provide design flexibility by allowing integration of the fuel cells with the structure of the device they are to power which reduces interior space requirements of the fuel cells, maximizing the volume available for fuel storage or other system components.

In some embodiments, fuel cells are provided in arrays which are less than about 5 mm thick (possibly not including a fuel plenum, if present). The fuel cells can be in the range of about 0.1 mm to about 2 mm thick, for example. Some fuel cell constructions can provide fuel cell layers that are even thinner than this. The layers can be free standing or supported. The layers can provide useful current and voltage levels, resulting in a power output that can be exploited by portable devices.

Examples of flexible fuel cell layers may be found in commonly-owned McLean, et. al., U.S. patent application Ser. No. 11/327,516, entitled “FLEXIBLE FUEL CELL STRUCTURES HAVING EXTERNAL SUPPORT” (issued as U.S. Pat. No. 8,410,747).

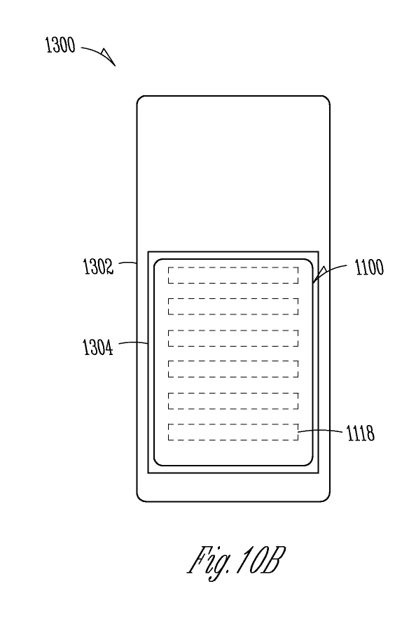

FIG. 10A illustrates one example of a fuel cell-powered electronic device, and more specifically, a mobile phone 1300 including the fuel cell system 1100. As discussed above, the present fuel cell system 1100 includes a space-saving fluid plenum 1210 (FIG. 8) transformable from a substantially volumeless enclosed region 1208 (FIG. 8). In this way, the fuel cell system 1100 can be made in compact configurations to fit within an existing electronic device, such as the mobile phone 1300. While a mobile phone 1300 is shown in FIG. 10A, the present fuel cell system 1100 can be configured in a small, compact volume for use with other portable electronics devices, such as laptop computers, computer accessories, displays, personal audio or video players, medical devices, televisions, transmitters, receivers, lighting devices including outdoor lighting or flashlights, electronic toys, power tools or any device conventionally used with batteries.

FIG. 10B illustrates a cross-sectional view of the mobile phone 1300, such as along line 1003B-1003B of FIG. 10A. Due to the very limited amount of space inside the mobile phone 1300, any internally positioned power source must be small and compact in size and shape. Beneficially, the present fuel cell system 1100 including the substantially volumeless enclosed region 1208 (FIG. 8) transformable into the fluid plenum 1210 (FIG. 8) can meet such size and shape requirements. In an example, a battery cover 1302 of the mobile phone 1300 includes a pocket 1304 about 0.6 mm deep to accommodate portions of the compact fuel cell system 1100, such as the fluid manifold 1202 (FIG. 8) and the fuel cell layer 1112 (FIG. 8), which are coupled by the bond member 1110 (FIG. 8). In another example, the battery cover 1302 provides an external support structure to limit the outward deformation of the fuel cell layer 1112 away from the fluid manifold 1202 during powering operations of the mobile phone 1300. In this example, the battery cover 1302 includes multiple air access ports 1118 to allow the cathodes of the fuel cell layer 1112 to receive air for use as an oxidizing agent.

The present fuel cell system can be used to adequately power other electronic devices in addition to the mobile phone 1300 (FIGS. 10A-10B), such as a laptop computer. The fuel cell system is positioned within an outer casing of the laptop display portion. The outer casing can include one or more air access ports to allow the fuel cell system with access to ambient air.

As discussed above, the fuel cell system 1100 can include one or more fluid pressure regulator devices 1126 to control the flow of fuel pressure coming out of the fluid reservoir 1102 (FIG. 7) by reducing a primary (higher) fluid pressure present in the fluid reservoir 1102 to a more constant secondary (lower) fluid pressure for delivery to the fuel cell layer 1112 (FIG. 7).

A single fluid pressure regulator device 1126 may be used or alternatively, it is contemplated that a fluid pressure regulator assembly 1104 including multiple regulators 1126 can be used with the present fuel cell system 1100 (FIG. 7). The present inventors have recognized that it may be beneficial in some examples for the fuel distribution flow to the enclosed region, and ultimately consumed by the anodes of the fuel cell layer 1112, be uniform. Thus, instead of relying on a single point of fluid pressure regulation control from the fluid reservoir 1102 and single inlet to the fluid manifold 1202, the fluid pressure regulator assembly 1104 can be used to provide active, local, and uniform control of fuel pressure and flow applied into and through (via material directing recesses 1120) the fluid manifold 1202. In an example, the multiple fluid regulator devices 1126 can be formed on the same layers, resulting in co-planar fluid regulator devices. Further, multiple inlets and/or outlets may be employed to direct fluid to and from fluid manifold 1202. And, further still, the inlets may be located on the major or the minor sides of fluid manifold 1202.

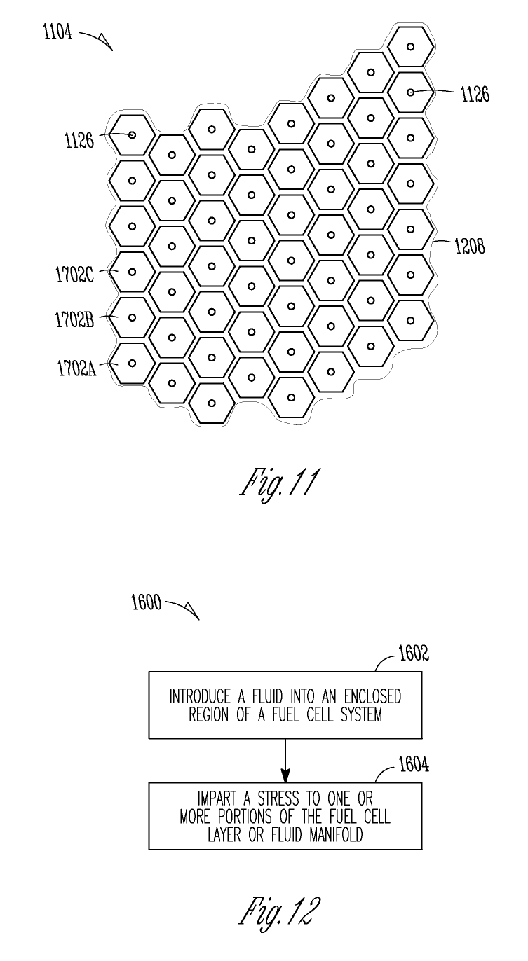

FIG. 11 illustrates a cross-section view of the array of fluid pressure regulator devices 1126 of the fluid pressure regulator assembly 1104, as constructed in accordance with an example. As shown in FIG. 11, the array of fluid pressure regulator devices 1126 can be spatially distributed so that each regulator distributes fuel or other reactant fluid into a different portion of the enclosed region 1208. In an example, the enclosed region 1208 is partitioned into a number of discrete regions 1702A, 1702B, 1702C, etc. as shown, with each region served by one or more fluid pressure regulator devices 1126. In another example, each fluid pressure regulator device 1126 acts independently from the others to maintain proper fuel pressure in the respective region of the enclosed region 1208 for steady delivery of fuel to the anodes of the at least one fuel cell 1112 (FIG. 7).

The fluid manifold 1202 includes at least one conduit layer that, in an option, is relatively thin, for example, when compared with the length and width. In an example, the thickness of conduit layer 1108 is generally less than about 1 mm. In another example, the thickness of conduit layer 1108 is about 50 μm-1 mm. In another example, the width and length of conduit layer 1108 is about 1 mm and 100 mm, respectively. The width, length, or thickness can be altered for geometry of the fuel cell system 1100 (FIG. 7) in which the manifold is installed.

Conduit layer 1108 further includes at least one material directing recess 1120 therein. Material directing recess 1120, in an option, extends through the conduit layer 1108, from one side to the other side. The conduit layer 1108 is optionally formed of metals, plastics, elastomers, or composites. Material directing recess 1120 can be etched, stamped, or otherwise created within or through the conduit layer 1108. In another option, material directing recess 1120 can be drilled within or through the conduit layer 1108, formed with a laser, molded in the layer, formed via die cutting or otherwise machined in the layer. In an example, material directing recess 1120 has a width of about 5 to 50 times the depth of the recess. In another example, recess 1120 has a width about 1 mm-2 mm. In yet another example, material directing recess 1120 has a width of about 50-100 μm.

The fluid manifold 1202 further optionally includes at least one sealing layer 1106 and can include first and second sealing layers on opposite sides of the conduit layer 1108. This allows for material directing recess 1120 to be enclosed and form a conduit thorough which material can travel. The sealing layers can be coupled with the conduit layer 1108, for example, but not limited to, using adhesives, bonding techniques, laser welding, or various other conventional methods.

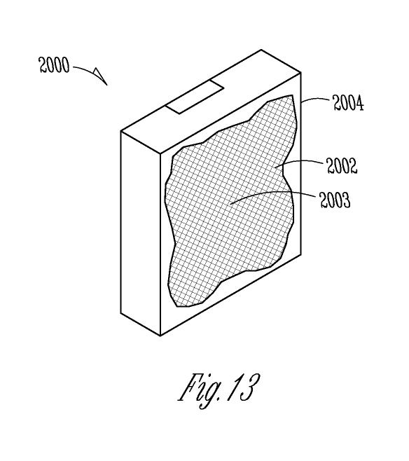

FIG. 12 illustrates a block flow diagram 1600 of a method of using a fuel cell system including a space-saving fluid plenum. A fluid may be introduced 1602 into an enclosed region of a fuel cell system, sufficient to increase the pressure within the enclosed region. A stress may be imparted 1604 to one or more portions of the fuel cell layer or the fluid manifold, sufficient to transform the enclosed region into a fluid plenum. The stress may cause a deformation in the fuel cell layer, fuel manifold or both, causing them to move away from each other. Introducing 1602 the fluid may occur at a pressure less than a fluid reservoir pressure, for example. One or more fuel cells in the fuel cell layer may be activated upon introducing the fluid 1602. Deforming 1604 may include urging portions of the fuel cell layer about 5 mm or less away from the fluid manifold.

The present fuel cell systems and methods include a space-saving fluid plenum transformable from a substantially volumeless enclosed region and in this way, allows for the creation of smaller, more compact fuel cell systems configurable to fit within an existing electronic device while still providing an effective structure to control the distribution of fluid, such as fuel, to the fuel cells. The enclosed region is located between a fluid manifold, which may include a fluid pressure regulator device(s), and a fuel cell layer. The enclosed region may be formed by a coupling between an outlet side of the fluid manifold and the fuel cell layer via a suitable bonding method. The coupling may be an adjacent bond, such that the enclosed space created is not able to function as a fluid distribution plenum without a stress being imparted on the fuel cell layer, fuel manifold or both by a fluid pressurization. In varying examples, the enclosed region transforms into a fluid plenum when a fluid exiting the manifold pressurizes the enclosed region, imparting a stress to one or more one or more portions of the fuel cell layer and/or the fluid manifold, which may result in portions or all of the layer and/or manifold to deform away from each other. In some embodiments, the stress imparted may result in deformation sufficient to provide a fuel plenum which enables operation of the fuel cell layer, but which may or may not be visibly or externally perceptible. The curvature of the fuel cell layer and/or fluid manifold shown in the figures is for illustrative purposes, and in some embodiments, the fuel cell layer and/or fluid manifold may be less curved, or may be substantially planar.

### Example 1

In an example, a flexible fuel cell layer with an array of strip-like fuel cells, constructed in accordance with commonly-owned U.S. patent application Ser. No. 11/047,560 (issued as U.S. Pat. No. 7,632,587), arranged in a generally parallel formation was bonded to a generally rigid fluid manifold using a structural adhesive member to form a peripheral seal. The fuel cell system further comprised internal adhesive support members arranged in a parallel configuration such that the current collecting structures of the fuel cell array were bonded directly to the fluid manifold such that the fuel cell array was substantially adjacent to the fluid manifold. When pressurized fluid (e.g. hydrogen) was introduced into the system, there was no visible deformation of the fuel cell layer, suggesting that no fluid plenum could have been formed; however, the fuel cell layer operated to produce electricity, implying that, in fact, a fuel plenum was indeed formed within the enclosed space between the fuel cell layer and the fluid plenum sufficient to enable fuel to react with the anodes of the fuel cell layer. Furthermore, in this example, no external supports were employed to enable operation of the fuel cell system, essentially allowing the fuel cell system to operate in a ‘self-supported’ configuration.

### Example 2

In a second example a flexible fuel cell layer with an array of strip-like fuel cells, constructed in accordance with commonly-owned U.S. patent application Ser. No. 11/047,560 (issued as U.S. Pat. No. 7,632,587), arranged in a generally parallel formation was bonded to a generally rigid fluid manifold using a structural adhesive member to form a peripheral seal. No internal supports were used; however, the system was dimensionally constrained using an external framework, such that the fuel cell layer was constrained substantially adjacent to the fluid manifold. In this embodiment, when pressurized fluid (e.g. hydrogen) was introduced into the system, there was a very small but visibly perceptible deformation of the fuel cell layer (i.e. about 0.5 mm total deflection), suggesting that a fluid plenum had been formed. Again, the fuel cell layer operated to produce electricity, confirming that a fluid plenum had been formed sufficient to enable fuel to react with the anodes of the fuel cell layer.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1.-20. (canceled)

21. A fuel cell system comprising:
a flexible fuel cell layer that includes at least two fuel cells substantially integrated within a two-dimensional fuel cell array;
a fluid manifold coupled to the flexible fuel cell layer with a peripheral seal to form an enclosed region between the fluid manifold and the flexible fuel cell layer, wherein the fluid manifold is also coupled to the flexible fuel cell layer with one or more internal supports with the internal supports bonded to both the flexible fuel cell layer and the fluid manifold and wherein the internal supports are configured to restrict outward expansion of the flexible fuel cell layer, and wherein the at least two fuel cells define at least a portion of the enclosure region, and wherein the fluid manifold is configured to maintain a fuel at a uniform pressure throughout the enclosed region; and
a cover that includes an interface structure proximate to the flexible fuel cell layer, wherein the interface structure is configured to affect one or more environmental conditions proximate to the flexible fuel cell layer.

22. The fuel cell system of claim 21, wherein the interface structure comprises at least one of an adaptive material that responds physically or chemically to a change in one or more environmental conditions external to the cover and a removable porous structure, the adaptive material and removable porous structure configured to affect the one or more environmental conditions proximate to the flexible fuel cell layer.

23. The fuel cell system of claim 21, wherein the interface structure comprises a shape memory adaptive material.

24. The fuel cell system of claim 21, wherein the one or more environmental conditions proximate to the flexible fuel cell layer includes a humidity level, a temperature, a pollutant level and a contaminant level.

25. The fuel cell system of claim 21, wherein the interface structure is electrically conductive.

26. The fuel cell system of claim 21, wherein the flexible fuel cell layer is flexible in whole.

27. The fuel cell system of claim 21, wherein the fluid manifold includes a manifold conduit layer and a first sealing layer and wherein the manifold conduit layer and the first sealing layer define a channel through which the fuel can travel.

28. The fuel cell system of claim 27, wherein the fluid manifold further includes a second sealing layer and wherein the first sealing layer is coupled to a first side of the manifold conduit layer and the second sealing layer is coupled to a second side of the manifold conduit layer and wherein the first side of the manifold conduit layer is opposite the second side of the manifold conduit layer.

29. The fuel cell system of claim 28, wherein the fluid manifold defines multiple outlets, each outlet configured to direct fuel out of the fluid manifold and into the enclosed region.

30. The fuel cell system of claim 27, wherein the fluid manifold further includes a fluid pressure regulator assembly configured to reduce the pressure of the fuel as the fuel passes through the fluid manifold.

31. The fuel cell cover of claim 30, wherein the fluid pressure regulator assembly defines an array of co-planar fluid regulator devices.

32. The fuel cell system of claim 30, wherein the flexible fuel cell layer and the fluid manifold are configured to deform away from one another when the at least two fuel cells are producing electricity.

33. The fuel cell system of claim 32, wherein the flexible fuel cell layer and fluid manifold are configured to deform away sufficient to allow detection of the deformation by the naked eye.

34. The fuel cell system of claim 21, wherein the flexible fuel cell layer is configured to continuously produce electricity when the enclosed region is pressurized with the fuel at a uniform pressure throughout the enclosed region.

35. A fuel cell system comprising:
a flexible fuel cell layer; and
a cover that includes an interface structure proximate to the flexible fuel cell layer, wherein the interface structure includes an adaptive material that defines a plurality of apertures configured to allow oxygen to pass through the cover to contact the flexible fuel cell layer, wherein the adaptive material is configured to alter a dimension of the apertures in response to a change in an environmental condition or to an applied signal and wherein the apertures pass through the adaptive material, and wherein the adaptive material is a woven material.

36. The fuel cell system of claim 35, wherein the adaptive material includes a shape memory alloy or a shape memory polymer.

37. The fuel cell system of claim 35, wherein the plurality of apertures are arranged in a non-uniform active area and wherein the non-uniform active area has a first area closer to an edge of an active area of the flexible fuel cell layer and a second area closer to a center of the active area and wherein a porosity of the first area is higher or lower than a porosity of the second area.

38. The fuel cell system of claim 35, wherein the cover is secured to the system with an attachment mechanism that includes a portion of a clip or a snap attachment device.

39. The fuel cell system of claim 35, further including a removable access plate, the removable access plate includes a second interface structure, the second interface structure including a second adaptive material that defines a second plurality of apertures in the removable access plate and wherein the removable access plate is secured to the cover with an attachment mechanism that includes a clip or a snap attachment device.

40. A fuel cell system comprising:
a flexible fuel cell layer that includes at least two fuel cells substantially integrated within a two-dimensional fuel cell array;
a fluid manifold coupled to the flexible fuel cell layer with a peripheral seal to form an enclosed region between the fluid manifold and the flexible fuel cell layer, wherein the fluid manifold is also coupled to the flexible fuel cell layer with one or more internal supports with the internal supports bonded to both the flexible fuel cell layer and the fluid manifold and wherein the internal supports are configured to restrict outward expansion of the flexible fuel cell layer, and wherein the at least two fuel cells define at least a portion of the enclosure region, and wherein the fluid manifold is configured to maintain a fuel at a uniform pressure throughout the enclosed region; and
a cover that includes an interface structure proximate to the flexible fuel cell layer, wherein the interface structure is configured to affect one or more environmental conditions proximate to the flexible fuel cell layer and wherein the interface structure comprises a shape memory adaptive material, and wherein the interface structure includes a filter element configured to exclude an atmospheric contaminant, and wherein the adaptive material is a woven material that includes fibers, wherein the fibers increase the porosity of the woven materials by increasing in length as humidity increases and wherein the fibers decrease the porosity of the woven materials by shortening in length when the humidity decreases.
